(19) United States
(12) Patent Application Publication
(10) Pub. No.: US 2012/0192971 A1
(43) Pub. Date: Aug. 2, 2012

(54) Low-pressure inflatable valve

(76) Inventors: Albert John Hofeldt, Miami Beach, FL (US); Mark Gaspich, Vero Beach, FL (US); Caroline Grace Gaspich, Vero Beach, FL (US)

(21) Appl. No.: 12/931,312

(22) Filed: Jan. 28, 2011

(51) Int. Cl. F16K 21/04

(52) U.S. Cl. 137/511

(57) ABSTRACT

A low-pressure valve that inserts into in a drainage system having has an inflatable balloon which fixates the value housing to a pre-existing drainage pipe to prevent backflow when the hydrostatic pressure is greater distal to the valve than proximal to the valve.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF INVENTION

Global warming has lead to higher costal tides and street flooding in some cities. Before flooding occurs from overflowing of the seawalls, reverse flow through the street drain system flood the streets. Once the hydrostatic pressure at the point where a drain pipe passes through the seawall exceed the pressure at the street drain, salt water flows from the costal body of water into the street. Once the pipe is devoid of air, siphoning occurs and the flow rate increases. The flow will continue as long as the height of the tide exceeds the height of the street, that is, whenever the hydrostatic pressure gradient is greater at the outflow point than at the street drain inlet.

Some cities do not have check valves or have inadequate check valves in the street drains. The refluxing of salt water not only causes water damage to buildings but also causes corrosion of metal parts of vehicles, such as, brakes, wheels and body panels. Once salt water is in contact with automobile parts the deterioration process begins. Rusting takes time after salt exposure and the damage is not recognized until months later. Miami Beach has had salt water back flow problems for years in areas that are below or near sea level and much damage to automobiles has occurred.

An easy to install check valve would immediately prevent backflow and prevent water damage to building and corrosion of metal automobile parts. The use of such a value could be permanent or a temporary emergency measure, a stop-gap until costly excavation and value repair or placement is feasible. An inflatable fixated value would be applicable to prevent tidal backflow because the backflow pressure is low, the pressure of a column of water the diameter of the drainage pipe and the height of the tide above the level of the street drain.

### BRIEF SUMMARY OF THE INVENTION

In accordance with a preferred embodiment of the invention, there is, disclosed a low pressure water value that is insertable into a street drainage pipe, that has an inflatable balloon surrounding the valve housing, that has a sealable tube to inflate the balloon with gas or fluid, and that when the balloon is inflated, pressure between the pipe wall and the value housing maintains the value securely within the pipe. The valve can be used as a permanent installation or as an emergency installation when a permanent valve is malfunctioning or non-existent.

### BRIEF DESCRIPTION OF THE DRAWINGS

The drawings constitute a part of the specifications and include exemplary embodiments to the invention, which may be embodied in various forms. It is to be understood that in some instances various aspects of the invention may be shown exaggerated or enlarged to facilitate an understanding of the invention.

FIG. 1. Shows a perspective see-through view of ball valve 10 with the ball occluding backflow.

FIG. 2 Shows a longitudinal cross-sectional view of ball value 10 with the ball occluding backflow.

FIG. 3 Shows a vertical cross-sectional view through the distal end of value 10.

FIG. 4. Shows a perspective see-through view of ball valve 10 with the ball open for street drainage.

FIG. 5 Shows a longitudinal cross-sectional view of value 10 open for street drainage.

FIG. 6 Shows a vertical cross-sectional view through the distal end of value 10 with the ball at the distal end of the valve.

FIG. 7. Shows a perspective see-through view of ball valve 11 open for street drainage.

FIG. 8 Shows a longitudinal cross-sectional view of ball value 11 open for street drainage.

FIG. 9 Shows a vertical cross-sectional view through the distal end of value 11 with the ball at the distal end of the valve.

FIG. 10. Shows a longitudinal cross-sectional view of ball value 12 with the tethered ball occluding backflow.

FIG. 11. Shows a longitudinal cross-sectional view of ball value 12 open for street water drainage.

FIG. 12. Shows a perspective see-through view of flapper valve 13.

FIG. 13 Shows a longitudinal cross-sectional view of flapper value 13 with the flapper open for street water drainage.

FIG. 14 Shows a longitudinal cross-sectional view of flapper value 13 with the flapper occluding backflow.

### DETAILED DESCRIPTION OF INVENTION

Detailed descriptions of the preferred embodiment are provided herein. It is to be understood, however, that the present invention may be embodied in various forms.

Therefore, specific details disclosed within are not to be interpreted as limiting, but rather as a basis for the claims and as a representative basis for teaching one skilled in the art to employ the present invention in virtually any appropriately detained system, structure or manner. The description is reference to a street drainage system by is applicable to other gravity drainage systems.

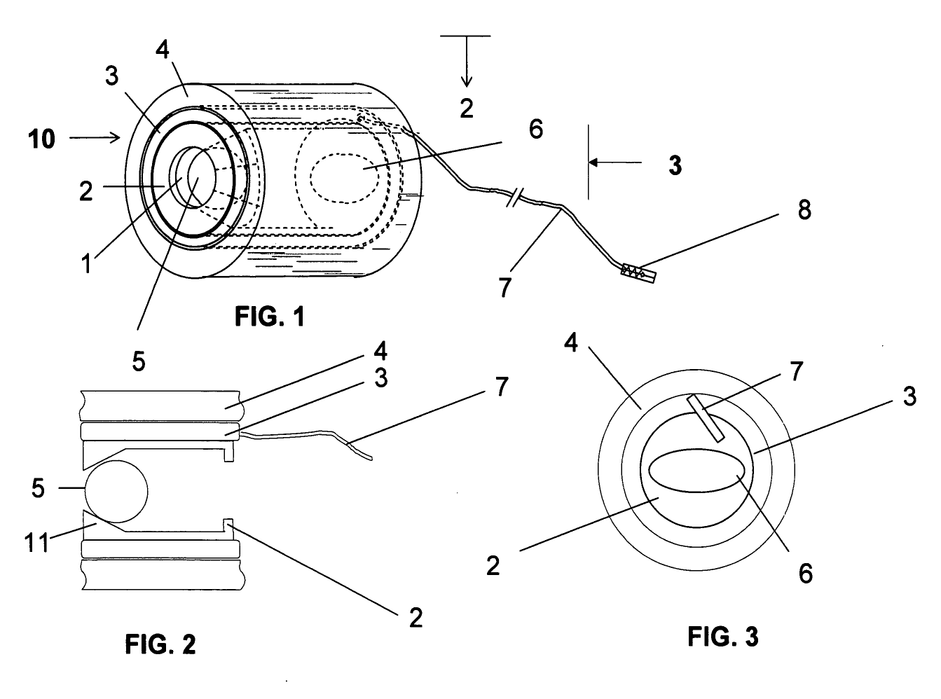

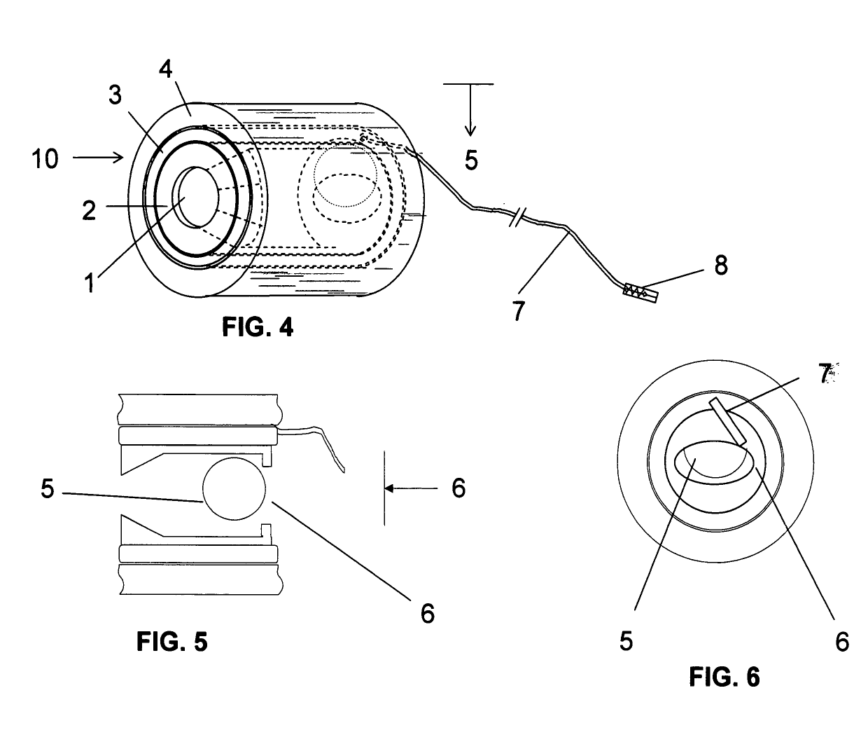

The invention is a low-pressure valve having a circumferential inflatable element or balloon as illustrated by value 10 in FIG. 1 that can be inserted into a pre-existing drainage system through a street drain inlet and fixed into position by the pressure of inflated balloon 3 that is located between drainage pipe wall 4 and value housing 2. Balloon 3 is inflated through tube 7 and tube 7 is closed by stop-lock 8. In FIGS. 1-3, ball 5 in value 10 is in the position to stop backflow in a drainage system that drains surface water to a body of water such as the ocean. In FIG. 1 is value 10 in a see-through perspective view showing inlet 1 through which the water or other fluid enter the valve 10 from the street, value wall 2, balloon 3, pipe wall 4 of the pre-existing drainage system, ball 5, outlet 6, tube 7 which is used to fill balloon 3, and stop-lock 8 that maintains the material within balloon 3. In FIG. 2 is value 10 in longitudinal section showing ball value 5 resting against value seat 11, the position of ball 5 when backflow occurs in the drainage system and ball 5 is forced against valve seat 11 to stop backflow of salty sea water caused by higher hydrostatic pressure distal to the valve than proximal to the valve, a situation that can occur at high tide. In FIG. 3 is value 10 in cross-section showing outlet 6 which is oval, a shape that captures ball 5 within value 10 and prevents ball 5 from occluding outlet 6 during outflow street drainage.

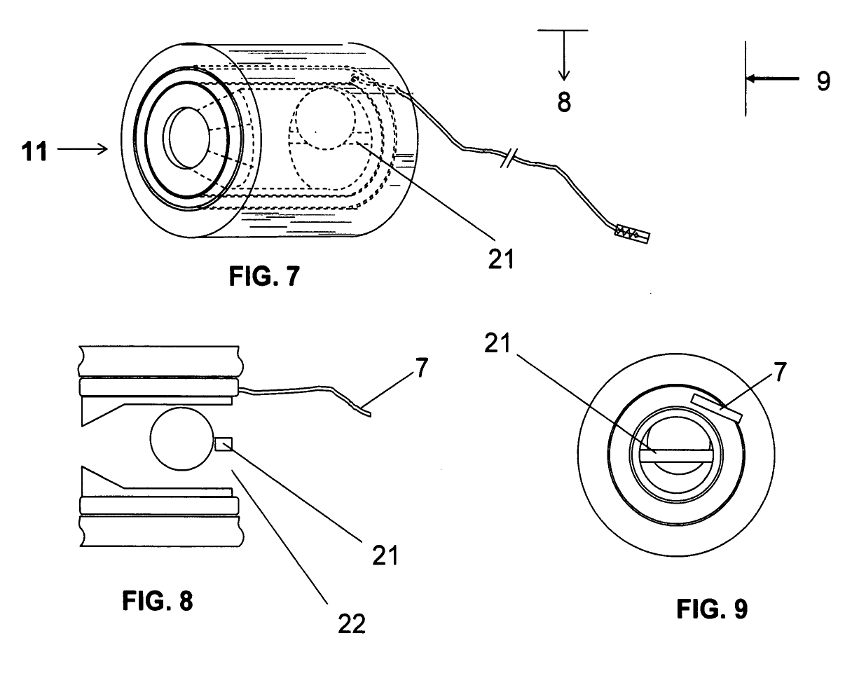

In FIGS. 4-6, ball 5 in value 10 is in the position that allows outflow drainage from a street to the sea and shows ball 5 resting against outlet 6. One diameter of oval outlet 6 must be less than the diameter of ball 5 to capture ball 5 within value 10 during periods when the street water is draining through valve 10.

Another embodiment that captures ball 5 is valve 11 as is seen in FIGS. 7-9 where bar 21 in outlet 22 stops ball 5 from exiting value 10 during periods when the street water is draining through valve 11.

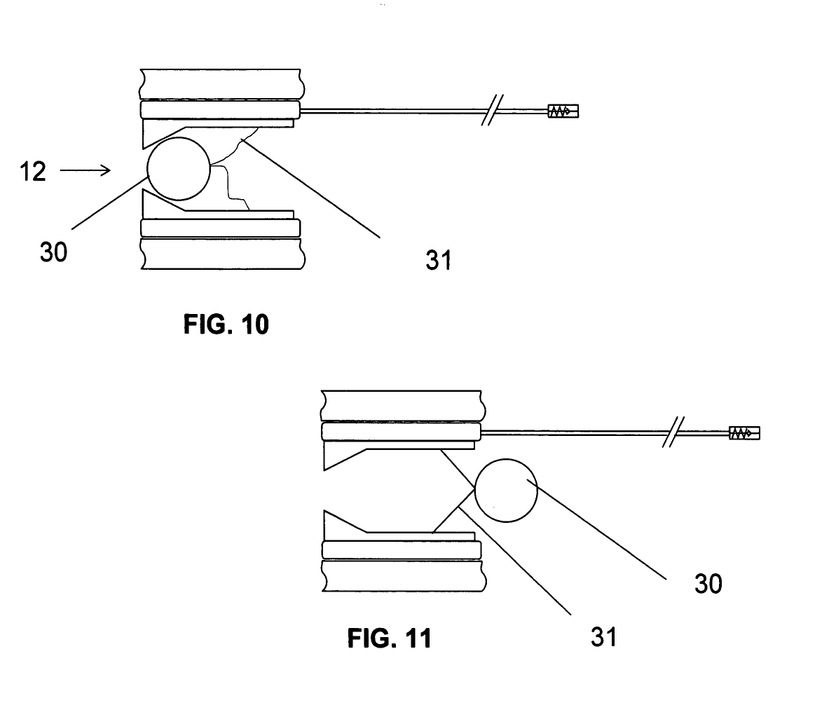

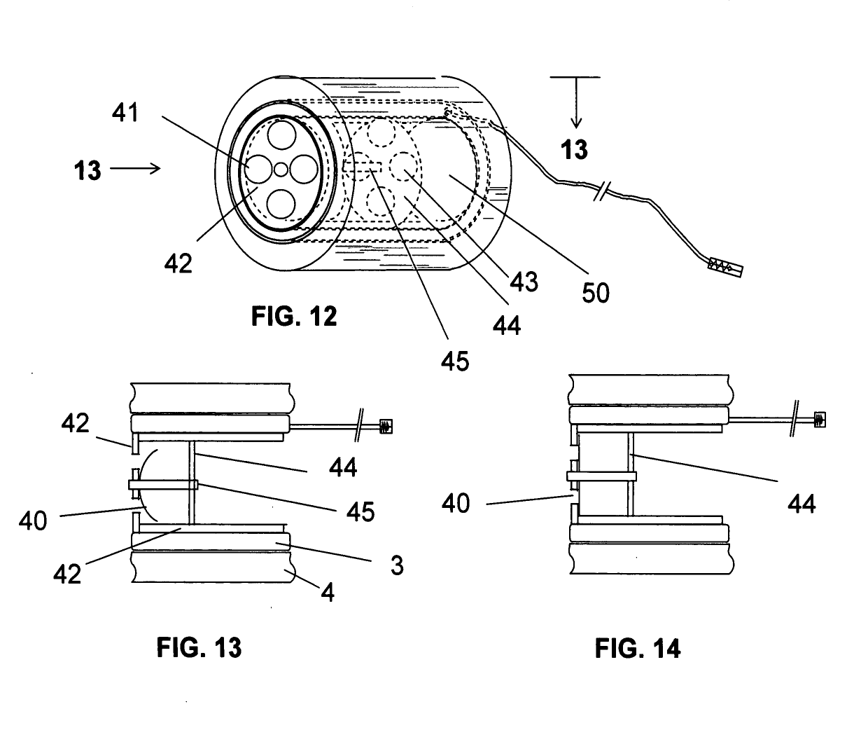

In another embodiment as seen in FIGS. 10 and 11 is value 12 having ball 30 tethered with cord 31 to value 12 to prevent ball 30 from exiting value 12 during outflow drainage from the street to the sea. During periods of street water drainage, ball 30 is tethered as seen in FIG. 11 and during periods of high tide and salt water is flowing retrograde in the drainage system, ball 30 is seated as seen in FIG. 10 and backflow of salt water is prevented.

Another embodiment is seen in FIGS. 13-14, where valve 13 has flapper 40 attached by support 44 and rod 45 to value housing 42. During periods or street drainage, water flows through opening 41 in housing 42, around flapper 40, through hole 43 in support 44 and exits through outlet 50. During periods of high tide and salt water is flowing retrograde in the drainage system, flapper 40 is seated against housing 42 as seen in FIG. 14 and backflow of salt water is prevented.

What is claimed is:

1. A device that is insertable into a drainage system for preventing backflow comprising:
a) a valve that closes by hydrostatic pressure,
b) an inflatable element surrounding the housing of said valve, and
c) a tube for filling said inflatable element with gas or fluid,
whereby, said value when inflated conforms and secures to the drainage pipe wall to provide drainage when the hydrostatic pressure favors outflow and to prevent backflow when the hydrostatic pressure does not favor outflow.

2. A device of claim 1 where said value is a ball valve.

3. A device of claim 1 where said value is a tethered ball valve.

4. A device of claim 1 where said value is a flapper valve.
